(19) United States
(12) Patent Application Publication
(10) Pub. No.: US 2025/0012999 A1
(43) Pub. Date: Jan. 9, 2025

(54) ARRANGEMENT FOR MOUNTING AN OPTICAL SYSTEM ON A BODY ELEMENT OF A VEHICLE

(71) Applicant: A. Raymond et Cie, Grenoble (FR)

(72) Inventors: Anthony Sanchez, Saint-Martin-le-Vinoux (FR); Marcel Lindgens, Zhenjiang (CN); Zhiwei Dong, Zhenjiang (CN)

(21) Appl. No.: 18/888,454

(22) Filed: Sep. 18, 2024

Related U.S. Application Data
(63) Continuation of application No. 17/609,564, filed on Nov. 8, 2021.

(30) Foreign Application Priority Data
May 17, 2019 (FR) 1905178

(51) Int. Cl. G02B 7/02; B60R 11/00; B60R 11/04; B60S 1/46; B60S 1/56; H04N 23/55

(52) U.S. Cl. CPC G02B 7/021; B60R 11/04; B60S 1/46; B60S 1/56; H04N 23/55; B60R 2011/0071; B60R 2011/0077; B60R 2011/0085

(57) ABSTRACT

An assembly is used to mount an optical system on a body element of a vehicle. The optical system comprises an image-capturing device and a device for projecting a fluid for cleaning the image-capturing device. The arrangement comprises a housing element for retaining the optical device in a mounting position, the housing element having an electrical interface configured to couple to an electrical connector of the image-capturing device when the latter is disposed in the mounting position, an element for holding the fluid projection device, and an element for fastening the housing element and the holding element to the body element of the vehicle.

### CROSS-REFERENCE TO RELATED APPLICATIONS

This application is a continuation of U.S. patent application Ser. No. 17/609,564, filed Nov. 8, 2021, which is a national phase entry under 35 U.S.C. § 371 of International Patent Application PCT/EP2020/059079, filed Mar. 31, 2020, designating the United States of America and published as International Patent Publication WO 2020/233878 A1 on Nov. 26, 2020, which claims the benefit under Article 8 of the Patent Cooperation Treaty to French Patent Application Serial No. 1905178, filed May 17, 2019, the disclosure of each of which is hereby incorporated herein in its entirety by this reference.

### TECHNICAL FIELD

The present disclosure relates to an arrangement for mounting an optical system on a body element of a vehicle.

### BACKGROUND

It is increasingly common to equip vehicles, in particular motor vehicles, with image-capturing devices. This may thus be a reversing camera integrated into the rear trunk door of the vehicle or its cowl, or integrated into an exterior mirror to provide rear side images of the environment. Document EP3149433 proposes a mounting arrangement for such a device. It can also be a remote sensing laser device (generally designated by the acronym “LIDAR”) or an infrared image sensor.

In document US2019028618, an image-capturing device is described that is intended to equip a motor vehicle. This device is supplied in a modular and compact form to be integrated into all types of body elements. The modular device consists of a plastic case holding an optic. The case comprises and protects an integrated electronic image sensor arranged on a printed circuit, facing the optic. The case is closed by a cover carrying an electrical connector. This connector is electrically connected to the printed circuit and can meet a connection standard, for example, FAKRA, facilitating its electrical connection to a vehicle computer, via a standard connection cable.

The optic of an image-capturing device, such as those described in the preceding documents, is liable to be soiled by rain, splashes or dust, which leads to a degradation in the quality of the images provided, and which may pose safety concerns. To solve this problem, provision has been made to place a device for projecting a cleaning fluid on the vehicle and in the immediate vicinity of the optic of the image-capturing device. By projecting this fluid (a liquid or compressed air) as needed onto the optic of the image-capturing device, the aim is to eliminate the particles or the material that is obstructing the optic in order to regain satisfactory image quality. Such a solution is described, in particular, in documents WO2018043743, US20180345917 and EP2873571, in which the cases of the image-capturing device and the fluid projection device are directly assembled to a support.

### BRIEF SUMMARY

It is generally sought to simplify the assembly of the parts making up a vehicle, and, in particular, those to be placed on body elements of this vehicle. The present disclosure aims to provide an arrangement facilitating the mounting of an optical system comprising an image-capturing device and of a device for cleaning this device.

With a view to achieving this aim, the object of the present disclosure provides an arrangement for mounting an optical system on a body element of a vehicle, the optical system comprising an image-capturing device and a device for projecting a fluid for cleaning the image-capturing device, the arrangement comprising:
a housing element for retaining the optical device in a mounting position, the housing element being provided with an electrical interface configured to couple with an electrical connector disposed on a case of the image-capturing device when the latter is retained in the mounting position;
an element for holding the fluid projection device aiming to place the latter in a functional position with respect to the image-capturing device disposed in the mounting position; and
an element for fastening the housing element and the holding element to the body element of the vehicle.

According to other advantageous and non-limiting features of the present disclosure, taken alone or in any technically feasible combination:
the housing element has a side wall in which is arranged at least one flexible tab having a free end bearing a notch, the flexible tab being able to deform to allow the introduction of the optical image-capturing device in the housing element and to close the notch thereon when it is disposed in the mounting position;
the housing element has a bottom and the electrical interface comprises a connector disposed on the bottom of the housing element;
the electrical interface comprises a connection cable electrically connected to the connector disposed on the bottom of the housing element;
the housing element and the holding element of the projection device are part of the same main body;
the fastening element comprises a plurality of flexible tabs disposed on the main body and configured to snap onto the body element;
the fastening element comprises a plurality of snap-on feet disposed on the main body and configured to enter openings arranged on the body element;
the mounting arrangement comprises a locking element selectively movable in an unlocked position in which the snap-on feet can be removed from the openings of the body element and in a locking position in which the snap-on feet cannot be removed from the openings of the body element;
the fastening element is carried by an intermediate part fastened in a reversible manner to the main body;
the intermediate part comprises two parts connected by a connecting ring, each part being configured to slide in an assembly rail arranged on the main body;
the fastening element and the holding element of the fluid projection device are carried by an intermediate part reversibly fastened to the housing element;
the intermediate part is irreversibly fastened to the body element;
the fastening element comprises a plurality of metal clips configured to cooperate with retaining elements provided on the body element of the vehicle;
the fastening element comprises an adhesive material disposed on the intermediate part; and
the intermediate part comprises elements for adjusting the angular position of the housing element.

### BRIEF DESCRIPTION OF THE DRAWINGS

Other features and advantages of the present disclosure will become apparent from the detailed description of the present disclosure that follows with reference to the accompanying figures, in which:

FIGS. 1A to 1D show a mounting arrangement according to a first embodiment;

FIG. 2A shows a variant of the first embodiment;

FIG. 2B shows the variant of FIG. 2A in exploded view;

FIGS. 3A and 3B show a mounting arrangement according to another embodiment;

FIGS. 4A to 4D show a mounting arrangement according to another embodiment; and

FIGS. 5A to 5D show a mounting arrangement according to yet another embodiment.

### DETAILED DESCRIPTION

In the remainder of this description, the term “optical system” will denote an assembly including an image-capturing device 2′ and a fluid projection device 3′ that it is sought to assemble to a body element of a vehicle. Additionally, the term “image-capturing device” denotes any device capable forming a representation of the environment of the vehicle; it may be, in particular, an image sensor in the visible range, or in the infrared, or in any other wavelength range. It can also be a laser-based device, such as a LIDAR, as has already been discussed herein. In all cases, the image-capturing device is provided in modular form: it comprises a case, for example, made of plastic, retaining an optic. The case comprises and protects a sensor disposed on a printed circuit. The case carries an electrical connector, electrically connected to the printed circuit.

In the chosen approach, the optical system can be pre-mounted on a mounting arrangement 1 in order to facilitate its assembly to the body element. For this purpose, the body element is provided with openings configured to receive the optic of the image-capturing device 2′ and an end nozzle of the projection device 3′.

Very generally, and with reference to the figures, a mounting arrangement 1 of the optical system in accordance with the different embodiments making up the present description comprises:
a housing element 2 for retaining an optical image-capturing device 2′ and interfacing electrically with this device;
a holding element 3 of a fluid projection device 3′;
a fastening element 4 for fastening the housing element 2 and the holding element 3 to a body element of a vehicle.

The housing element 2 is formed, for example, by four side walls defining a housing 5 in which the image-capturing device 2′ can be placed, in the mounting position. The image-capturing device 2′ can be fastened by any means to the housing element 2, for example, in the housing 5, in order to retain it in this mounting position.

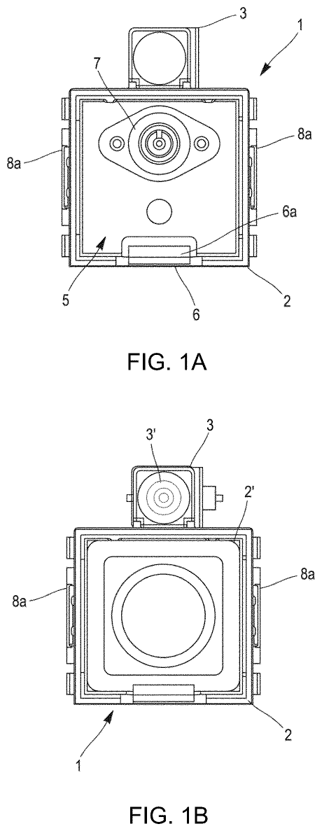

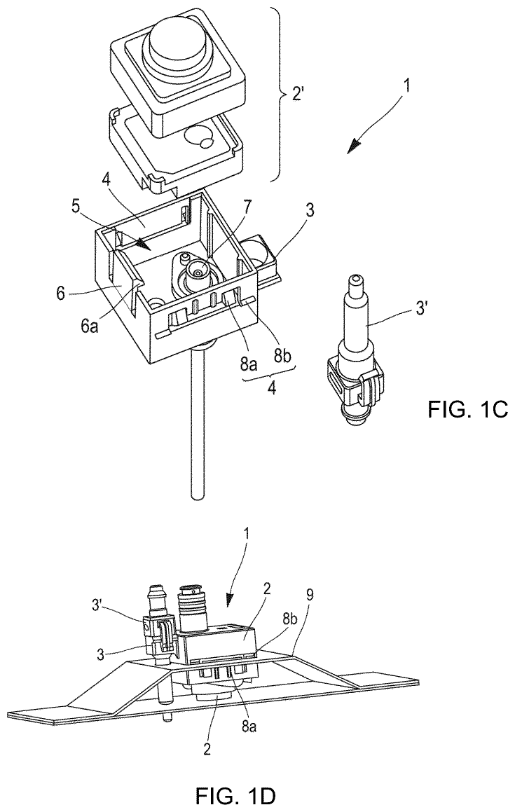

In the example shown in FIGS. 1A to 1D, the housing element 2 has a flexible tab 6 arranged on one of the side walls. The flexible tab 6 carries a notch 6a at its free end, the notch being oriented toward the inside of the housing 5. The flexible tab 6 can be deformed toward the outside of the housing to allow the image-capturing device 2′ to be introduced into the housing 5 and to close on the latter when it is placed in the mounting position. In this position, the electrical connector of the optical image-capturing device 2′ is coupled to an electrical interface 7 with which the housing element 2 is provided.

In general, the electrical interface 7 of the housing element 2 has a first side, emerging inside the housing 5 in the case shown in FIG. 1A, allowing it to be connected to the electrical connector of the image-capturing device 2′ when the latter is retained by the housing element 2. As is very visible in FIG. 1A, the electrical interface 7 may comprise a connector arranged on a wall forming the bottom of the housing element 2. The electrical interface 7 also comprises a second side, emerging outside the housing 5 in the case shown in FIG. 1C, allowing it to be connected to connection cables, in order to electrically connect the image-capturing device 2′ to a computer of the vehicle. The first and the second side of the electrical interface 7 can meet different standards, for example, the FAKRA standard. The connection between the electrical interface 7 and the housing element 2 can be tight. The electrical interface 7 may comprise a cable section, the end of which may be fitted with a connector, in order to facilitate coupling to the wiring of the vehicle, in particular, when the optical system must be positioned in a location of the vehicle that is difficult to access.

The holding element 3 aims to keep the fluid projection device 3′ in a functional position with respect to the image-capturing device 2′ when the latter is in the mounting position. The fluid projection device 3′ has one end for connection to a port for supplying the fluid, and another end forming a nozzle for projecting the fluid. In the functional position, the fluid is effectively and precisely projected by the end nozzle onto the optic of the image-capturing device 2′. The holding element 3 is able to securely keep the projection device 3′ in its functional position. They can be secured, in particular, to one another by clipping, as is the case in the illustrated example.

In certain embodiments, the housing element 2 and the holding element 3 are secured to one another. They can be part of the same main body of the mounting arrangement 1. This main body may be made of plastic. In a variant of these embodiments, it could be envisaged to form the housing element 2 and the holding elements 3 in two parts that are separated, but secured to one another without any degree of freedom, to form the main body.

In order to assemble the optical system to a body element of a vehicle, the mounting arrangement 1 also provides a fastening element 4. This fastening element 4 can take many forms, as will be presented in the various embodiments of the present description.

In the embodiment shown in FIGS. 1A to 1D, the fastening element 4 is formed by flexible tabs 8a formed on opposite side walls of the housing element 2. These flexible tabs 8a respectively carry ramps arranged on their outer face, that is to say, the faces that are not turned toward the inside of the housing 5. These ramps make it possible to progressively deform the flexible tabs during the assembly of the mounting arrangement 1. The outer faces of these side walls also bear abutment zones 8b forming, in respective combination with the flexible tabs 8a, grooves in which a fastening support 9 of the body element can be accommodated. FIG. 1D shows the mounting arrangement 1 of the first embodiment assembled to such a fastening support 9.

The fastening support 9 here is provided with an opening in which the mounting arrangement 1 can be placed and can snap into place using the fastening element 4, for example, using the flexible tabs combined with the stops that have just been described.

More generally, the fastening element 4 is configured to assemble the mounting arrangement 1 very simply on the body element, for example, by clipping, snap-fastening, elastic fitting or stapling. This assembly can be reversible or irreversible, that is to say, at least part of the mounting arrangement 1 is retained on the body element by the fastening element 4 without easy disassembly means.

It will be understood that the assembly of the optical system to the body element is particularly facilitated by the proposed mounting arrangement 1. The mounting arrangement 1 can in fact be delivered pre-assembled, that is to say, previously equipped, for example, by clipping as seen in the example of FIGS. 1A to 1D, with the image-capturing device 2′ and the projection device 3′. The pre-assembled assembly can be assembled on the body element in a single manual operation, for example, by snap-fastening onto a fastening support 9 or any other retaining element of the body element. Once mounted, the image-capturing device 2′ can be connected to a computer of the vehicle by simple wiring of the electrical interface 7. The projection device 3′ is in turn connected, on the side of its connection end, to a fluid distribution port.

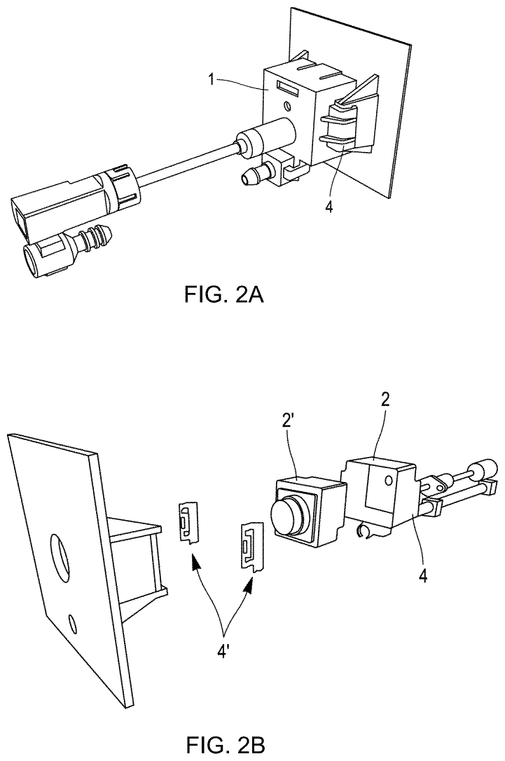

FIG. 2A shows a variant of the example shown in FIGS. 1A to 1D. According to this variant, the fastening element 4 is formed by flexible handles disposed on the main body forming the mounting arrangement 1. These flexible handles are configured to snap onto protruding ribs of the body element. This variant has all the advantages of the mounting arrangement 1 that have just been mentioned. It is, in particular, very simple to assemble to the body element of the vehicle. Metal parts 4′ can be provided that fit between the flexible handles and the ribs to reinforce the mounting of the assembly on the vehicle, as is clearly shown in FIG. 2B.

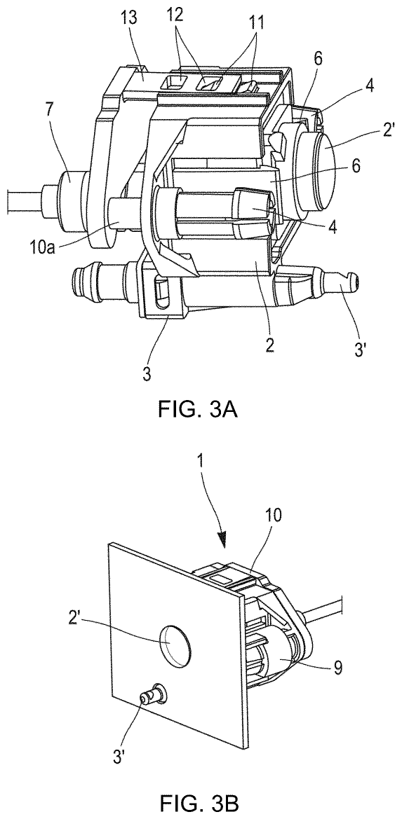

FIGS. 3A and 3B show a mounting arrangement 1 according to another embodiment. In this embodiment, there is indeed a housing element 2 secured to the holding element 3 in order to constitute a main body. Two opposite walls of the housing element 2 here are each provided with a flexible tab 6 for retaining the image-capturing device 2′ in the mounting position.

The fastening elements 4 of this embodiment here are made up of two snap-on feet. These feet are defined by a plurality of flexible parts, one end of which is connected to the main body and the other free end of which carries a fastening notch. These flexible parts are capable of approaching one another to pass through an opening of a retaining element 9 of the body element. The flexible parts retract after passing through the openings so as to secure the mounting arrangement 1 to the body element.

The mounting arrangement 1 of this embodiment also comprises a locking part 10. This carries two projecting parts 10a that are configured to penetrate respectively into the snap-on feet, between the flexible parts defining these feet, in order to block them so that they can no longer come closer to each other. This locks the fastening of the mounting arrangement 1 to the body element. Provision can be made, as shown in FIG. 3A, to provide the locking element with windows 12, carried by an arm 13. These windows 12 cooperate with at least one positioning notch 11, two notches 11 in the example of FIG. 3A, carried by an outer face of a wall of the housing element 2.

The locking part 10 can then be selectively placed in an unlocked position (shown in FIG. 3A) in which the projecting parts 10a are not fully inserted into the snap-on feet of the main body. The flexible parts defining these feet can then freely approach one another so as to allow the assembly of the optical system to a body element. This unlocked position is maintained by placing a positioning notch 11 in one of the windows 12.

The locking part 10 can also be selectively placed in a locked position, in which the projecting parts 10a are fully inserted into the snap-on feet. The flexible parts can then no longer come closer to one another and the fastening is effectively locked. This position is maintained by placing each positioning notch 11 in a window 12 of the arm 13, as clearly shown in FIG. 3A.

The locking part 10 can easily be slid from an unlocked position to a locked position and vice versa. In this way, the optical system retained by the mounting arrangement 1 is reversibly fastened to the body element of the vehicle, which can be advantageous when it is necessary, for example, to replace this element of a damaged vehicle.

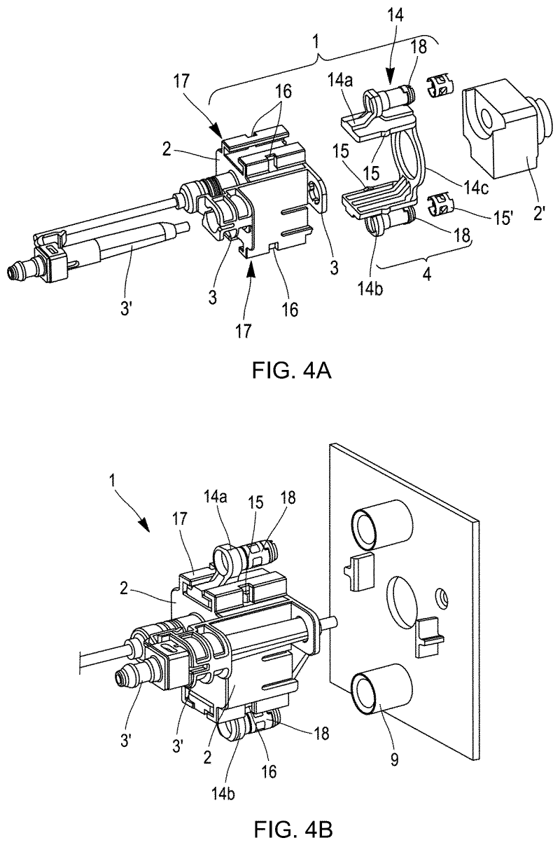

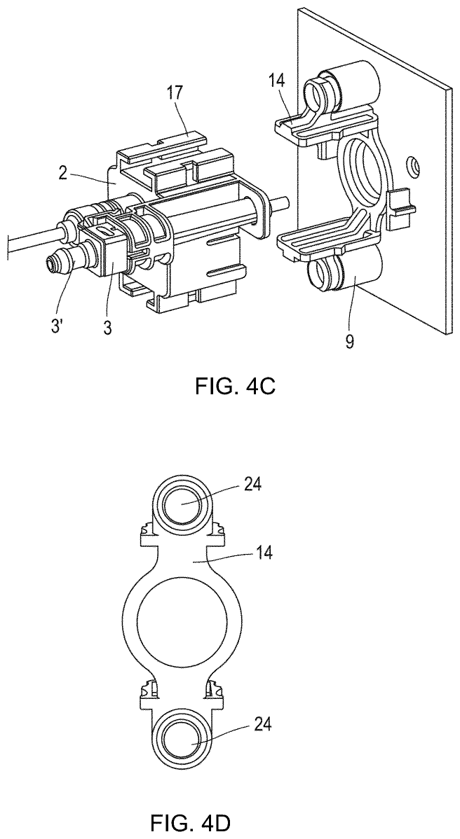

FIGS. 4A to 4C show a mounting arrangement 1 according to another embodiment. In this embodiment, the housing element 2 is indeed found secured to the holding element 3, which constitutes a main body as in the previous embodiments. In this embodiment, however, the fastening element 4 comprises an intermediate part 14 fastened in a reversible manner to the main body. In the example shown in FIG. 4A, this intermediate part is formed by two parts 14a, 14b that are interconnected by a connecting ring 14c and arranged on either side of this ring 14c. The connecting ring 14c avoids masking the optic of the image-capturing device 2′ when the latter is placed in the mounting position in the housing element 2.

The outer surfaces of two opposite walls of the housing element 2 carry rails 17 in which the two parts 14a, 14b of the intermediate part 14 can slide. These rails 17 can have side openings 16 in which lugs 15′ placed laterally on the parts 14a, 14b can engage in order to assemble the intermediate part 14 to the main body and to fix their relative position.

The intermediate part 14 is provided with two feet 18 respectively carried by the two parts 14a, 14b, each foot 18 receiving a metal clip 15 in the form of a ring. These clips 15 in the form of rings, once securely positioned on the feet 18, are configured to cooperate with retaining elements 9 arranged on the body element of the vehicle, so as to fasten the intermediate part 14 to this element in a non-reversible manner. As is well known per se, each metal clip 15 can comprise a projecting claw that can be introduced into the retaining element 9, but which blocks its removal.

The mounting arrangement 1 according to this embodiment can be originally delivered pre-assembled, that is to say, by having previously fastened the fluid projection device 3′ and the image-capturing device 2′ on the main body and having placed the intermediate part 14 provided with the metal clips 15 on the main body. This assembly can be mounted in a single step on the body element by stapling it to the retaining elements 9 of the vehicle (FIG. 4B). If it is necessary to disassemble the optical system, the main body can be slid to separate it from the intermediate part 14 via the rails 17. The intermediate part 14 remains irreversibly fastened to the body element (FIG. 4C).

In a variant of this embodiment shown in FIG. 4D, the fastening element 4 can be formed by an adhesive material 24 disposed on the intermediate part 14; this adhesive material 24 can be activated, for example, by heating in order to irreversibly fasten the intermediate part 14 to the body element.

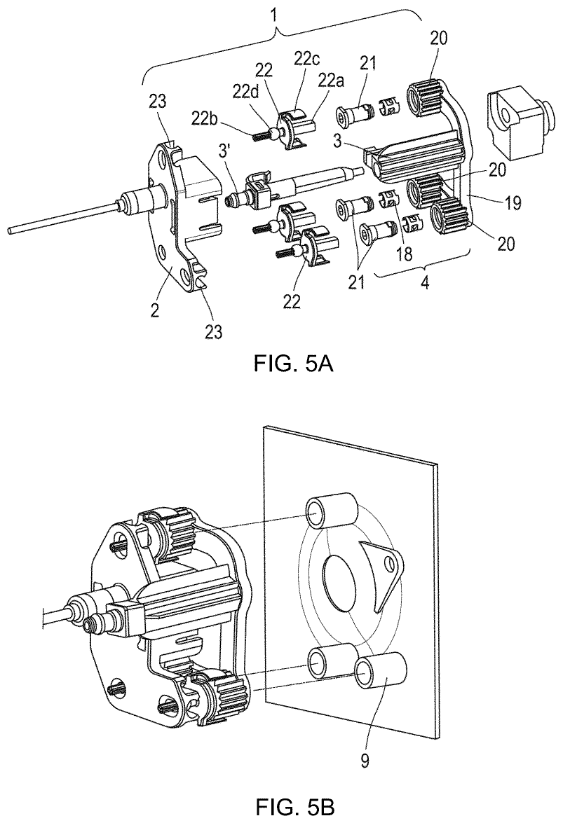

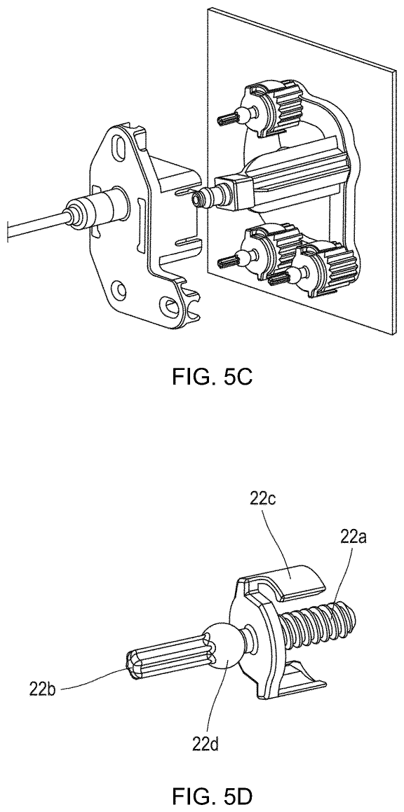

FIG. 5A to 5C show a mounting arrangement 1 according to yet another embodiment. In this embodiment, the fastening element 4 and the holding element 3 are both carried by an intermediate part 19, this intermediate part 19 being fastened in a reversible manner to the housing element 2 and in an irreversible manner to a retaining element 9 of the body element.

In this embodiment, the relative angular position of the housing element 2 can be adjusted with respect to the intermediate part 19. It is therefore possible, after mounting the mounting arrangement 1, to precisely adjust the orientation of the optic of the image-capturing device 2′, which can be important when the optical field is relatively narrow, as can be the case for LIDAR-type devices.

The intermediate part 19 carries three notched wheels 20, each wheel 20 having a central bore. These bores are configured to receive inserts 21, for example, plastic inserts, bearing ring-shaped metal clips 15 on their outer surface. These inserts 21 also have an axial recess carrying an internal thread. The ends of the inserts 21 that emerge from the notched wheels 20 are introduced into retaining elements 9 of the body element in order to irreversibly fasten the intermediate part 19 carrying the holding element 3 and the projection device therein 3′. In an alternative, it could also be considered to fasten the intermediate part 19 to the body element by way of an adhesive material. In this case, the inserts 21 would not be necessary, and the internal thread would be carried through the central bore of the wheels 20.

The housing element 2 is in turn reversibly coupled to the intermediate part 19 by way of a plurality of swivel parts 22, three in the illustrated example, to be respectively associated with the notched wheels 20.

Each swivel part 22, as is clearly visible in FIG. 5D, is formed by a central axis, a first end 22a of which carries an external thread configured to cooperate with the internal thread of the axial recess of an insert 21. A flexible part 22c of the swivel part 22 cooperates with the notches of a wheel 20 to allow the angular position of the swivel part 22 to be indexed with respect to the wheel 20, and therefore with respect to the progression by screwing of the swivel part 22 in the insert 21. The other end 22b of the central axis enters an opening made on the housing element 2. The opening makes the end 22b of the axis accessible from the outside, which can be shaped to be manipulated in rotation by a tool. The central axis also carries a spherical ball joint 22d, which is configured to clip into a clipping housing 23 of the housing element 2 to secure this housing element to the swivel parts 22 and therefore to the intermediate part 19.

The swivel parts 22 can thus be driven in rotation, the movement and angular position of which is indexed by the flexible part 22c housed in the notches of the wheels 20. The progression by screwing of a swivel part 22 into an insert 21 causes the displacement of the housing element 2 by rotation about an axis passing through the other two swivel parts 22. Advantageously, the three notched wheels 20, the central bores of which define three fastening points of the housing element, will be placed on the surface of the intermediate part 19 so that they form a right triangle. The notched wheel 20 and the swivel part 22 arranged at the right angle of this triangle constitute a pivot fastening point, the other two notched wheel-swivel part pairs then making it possible to orient the housing element 2 (and therefore the image-capturing device 2′) angularly and respectively along two axes that are perpendicular to one another.

It is noted that these elements for adjusting the angular position of the housing element 2 are completely compatible with the previous embodiment in which the housing element 2 and the holding element 3, which are secured with one another, were associated with an intermediate part 14.

Of course, the present disclosure is not limited to the embodiments described and it is possible to add variants without departing from the scope of the invention as defined by the claims.

What is claimed is:

1. A mounting assembly for mounting an optical system on a body element of a vehicle, the optical system comprising an image-capturing device and a device for projecting a fluid for cleaning the image-capturing device, the assembly comprising:
a housing element for retaining the image-capturing device in a mounting position, the housing element including an electrical interface configured to couple with an electrical connector disposed on a case of the image-capturing device when the image-capturing device is retained in the mounting position;
an element for holding the fluid projection device and placing the fluid projection device in a functional position with respect to the image-capturing device when the image-capturing device is disposed in the mounting position; and
an element for fastening the housing element and the holding element to the body element of the vehicle.
